(19) United States
(12) Patent Application Publication
(10) Pub. No.: US 2016/0369855 A1
(43) Pub. Date: Dec. 22, 2016

(54) ELECTROMECHANICAL SYSTEM FOR CONTROLLING THE OPERATING MODE OF A SELECTABLE CLUTCH ASSEMBLY AND AN OVERRUNNING COUPLING AND ELECTROMECHANICAL CONTROL ASSEMBLY USING THE SYSTEM

(71) Applicant: Means Industries, Inc., Saginaw, MI (US)

(72) Inventor: Ryan W. Essenmacher, Saginaw, MI (US)

(21) Appl. No.: 15/251,346

(22) Filed: Aug. 30, 2016

Related U.S. Application Data
(63) Continuation-in-part of application No. 14/933,345, filed on Nov. 5, 2015.
(60) Provisional application No. 62/076,646, filed on Nov. 7, 2014.
(60) Provisional application No. 62/259,713, filed on Nov. 25, 2015.

(51) Int. Cl. F16D 48/06; F16D 7/00; F16D 28/00

(52) U.S. Cl. CPC F16D 48/064; F16D 28/00; F16D 7/00; F16D 2023/123

(57) ABSTRACT

An electromechanical system for controlling the operating mode of a selectable clutch assembly and an overrunning coupling and electromechanical control assembly using the system are provided. A bi-directional, electrically-powered actuator assembly including an output member is coupled to a control member for selective, small-displacement, control member angular rotation about a first axis between different angular positions which correspond to different operating modes of the clutch assembly. The actuator assembly includes a rotary output shaft, a threaded screw shaft coupled to the output shaft to rotate about a second axis substantially perpendicular to the first axis and a cam having a contour surface. The cam is threaded onto the screw shaft to move linearly along the second axis upon rotary movement of the screw shaft. The output member rides on the contour surface of the cam so that the output member rotates with the control member about the first axis.

### CROSS-REFERENCE TO RELATED APPLICATIONS

This application is a continuation-in-part of U.S. application Ser. No. 14/933,345 filed Nov. 5, 2015, which, in turn, claims the benefit of U.S. provisional application Ser. No. 62/076,646 filed Nov. 7, 2014. This application also claims benefit of U.S. provisional application Ser. No. 62/259,713, filed Nov. 25, 2015.

### TECHNICAL FIELD

At least one embodiment of the invention generally relates to systems for controlling the operating mode of a selectable clutch assembly and, in particular, to electromechanical systems for controlling the operating mode of such assemblies.

### Overview

A typical one-way clutch (i.e., OWC) includes a first coupling member, a second coupling member, and a first set of locking members between opposing surfaces of the two coupling members. The one-way clutch is designed to lock in one direction and to allow free rotation in the opposite direction. Two types of one-way clutches often used in vehicular, automatic transmissions include:
roller type which includes spring-loaded rollers between inner and outer races of the one-way clutch. (Roller type is also used without springs on some applications); and
sprag type which includes asymmetrically shaped wedges located between inner and outer races of the one-way clutch.

One way clutches typically over run during engine braking rather than enable engine braking. It is for this reason there is a friction pack at the same transmission node. Selectable dynamic clutches can be used to prevent the over running condition and enable engine braking.

Controllable or selectable one-way clutches (i.e., OWCs) are a departure from traditional one-way clutch designs. Selectable OWCs often add a second set of struts or locking members in combination with a slide plate. The additional set of locking members plus the slide plate adds multiple functions to the OWC. Depending on the needs of the design, controllable OWCs are capable of producing a mechanical connection between rotating or stationary shafts in one or both directions. Also, depending on the design, OWCs are capable of overrunning in one or both directions. A controllable OWC contains an externally controlled selection or actuation mechanism. Movement of this selection mechanism can be between two or more positions which correspond to different operating modes. The selection mechanism is a separate system or assembly that is fixed relative to the OWC by same fastening technique. Such selection mechanism is fixed in a separate and subsequent operation after the OWC has been formed. That subsequent operation requires an additional work station, be it automated or otherwise, which increases, in particular, the manufacturing time and cost of the finished assembly.

In addition, the fact that separate, external parts may be mounted on or near the OWC in a source of quality defects and thus adds to the cost of making such controllable or selectable OWC's which may be significant on a mass production basis. Also, due to dimensional stack-up issues control element or selector plate binding can result especially over long term use.

Driven by a growing demand by industry, governmental regulatory agencies and consumers for durable and inexpensive products that are functionally comparable or superior to prior art products, a continuing need exists for improvements in clutches subjected to difficult service conditions such as extreme temperatures. This is particularly true in the automotive industry where developers and manufacturers of clutches for automotive applications must meet a number of competing performance specifications for such articles.

Another problem associated with prior art coupling and control assemblies is that it is undesirable to have a relatively large distance between the control element and the activator which moves the control element. A large distance reduces the amount of available space in which the assembly is located. For example, in a vehicle, the amount of space for such assemblies is typically quite limited.

U.S. Pat. No. 5,927,455 discloses a bi-directional overrunning pawl-type clutch. U.S. Pat. No. 6,244,965 discloses a planar overrunning coupling for transfer of torque. U.S. Pat. No. 6,290,044 discloses a selectable one-way clutch assembly for use in an automatic transmission. U.S. Pat. No. 7,258,214 discloses an overrunning coupling assembly. U.S. Pat. No. 7,344,010 discloses an overrunning coupling assembly. U.S. Pat. No. 7,484,605 discloses an overrunning radial coupling assembly or clutch.

Other related U.S. patent publications include 2012/0145506; 2011/0192697; 2011/0183806; 2010/0252384; 2009/0194381; 2008/0223681; 2008/0169165; 2008/0169166; 2008/0185253; and the following U.S. Pat. Nos. 8,079,453; 7,992,695; 8,051,959; 7,766,790; 7,743,678; and 7,491,151.

U.S. Pat. No. 8,272,488 discloses in its FIGS. 9a-9c (labeled as FIGS. 1a-1c, respectively, in this application), a “perpendicular actuating shift valve” latching mechanism, generally indicated at 500. A control plate or element 502 of a one-way clutch is provided which shifts or slides along a shift direction between pocket and recess plates (not shown) of the clutch to controllably cover and uncover struts 504 which are spring-biased within the pocket plate. A free end portion 506 of an actuating arm or pin, generally indicated at 508, may move within a curved pin recess or groove 510 formed in an outer surface 528 of a valve or piston, generally indicated at 512, in a direction substantially perpendicular to a shift direction of the control plate 502 during sliding movement of the piston or valve 512 within a bore 513 formed in a housing 514. The side walls or surfaces of the grooves 510 lock the pin 508 therebetween as shown in FIG. 1a to prevent movement of the pin 508 in a direction parallel to the shift direction of the control plate 502. The groove 510 may be curved and the free end portion 506 of the actuating arm 508 may simultaneously move within the groove 510 in both a direction substantially parallel to the shift axis and in a direction substantially perpendicular to the shift axis during movement of the piston 512 within the housing 514. Compression springs 516, also disposed within the bore 513, are biased between a cover 518 of the housing 514 and one end 520 of the valve 512. The plate 502 of the one-way clutch is disclosed in its overrun position in FIG. 1a and moves to its locked position in FIG. 1c. Application of a control pressure 522 through a control portion 523 of the housing 514 at the opposite end 524 of the valve or piston 512 causes the valve 512 to move against the biasing action of the compression springs 516 so that the actuating pin 508, which is secured to the control plate 502 at a pin attachment portion 526, moves within the curved pin recess or groove 510 formed in the outer surface 528 of the valve 512 as shown in FIGS. 1b and 1c. As shown in FIG. 1c, one of the struts 504 now extends through an aperture 530 formed in the control plate 502 to lock the one-way clutch.

Other U.S. patent publications which disclose controllable or selectable one-way clutches include U.S. Pat. Nos. 6,193,038; 7,198,587; 7,275,628; 8,602,187; and 7,464,801, and U.S. Publication Application Nos. 2007/0278061; 2008/0110715; 2009/0159391; 2009/0211863; 2010/0230226; and 2014/0190785.

Despite the above, a need exists to provide non-hydraulic clutch disengagement under load, especially during extremely low startup temperatures (i.e. −40° F. or lower) while conserving space in an automatic transmission environment.

Other U.S. patent documents related to the present application include: U.S. Pat. Nos. 2,947,537; 2,959,062; 4,050,560; 4,340,133; 4,651,847; 6,607,292; 6,905,009; 7,942,781; 8,061,496; 8,286,772; 2004/0238306; 2006/0185957; 2007/0034470; 2009/0255773; 2010/0022342; 2010/0255954; 2011/0177900; 2012/0090952; 2012/0152683; and 2012/0152687.

As used herein, the term “sensor” is used to describe a circuit or assembly that includes a sensing element and other components. In particular, as used herein, the term “magnetic field sensor” is used to describe a circuit or assembly that includes a magnetic field sensing element and electronics coupled to the magnetic field sensing element.

As used herein, the term “magnetic field sensing element” is used to describe a variety of electronic elements that can sense a magnetic field. The magnetic field sensing elements can be, but are not limited to, Hall effect elements, magnetoresistance elements, or magneto transistors. As is known, there are different types of Hall effect elements, for example, a planar Hall element, a vertical Hall element, and a circular vertical Hall (CVH) element. As is also known, there are different types of magnetoresistance elements, for example, a giant magnetoresistance (GMR) element, an anisotropic magnetoresistance element (AMR), a tunneling magnetoresistance (TMR) element, an Indium antimonide (InSb) sensor, and a magnetic tunnel junction (MTJ).

As is known, some of the above-described magnetic field sensing elements tend to have an axis of maximum sensitivity parallel to a substrate that supports the magnetic field sensing element, and others of the above-described magnetic field sensing elements tend to have an axis of maximum sensitivity perpendicular to a substrate that supports the magnetic field sensing element. In particular, planar Hall elements tend to have axes of sensitivity perpendicular to a substrate, while magnetoresistance elements and vertical Hall elements (including circular vertical Hall (CVH) sensing elements) tend to have axes of sensitivity parallel to a substrate.

Magnetic field sensors are used in a variety of applications, including, but not limited to, an angle sensor that senses an angle of a direction of a magnetic field, a current sensor that senses a magnetic field generated by a current carried by a current-carrying conductor, a magnetic switch that senses the proximity of a ferromagnetic object, a rotation detector that senses passing ferromagnetic articles, for example, magnetic domains of a ring magnet, and a magnetic field sensor that senses a magnetic field density of a magnetic field.

Modern automotive vehicles employ an engine transmission system having gears of different sizes to transfer power produced by the vehicle's engine to the vehicle's wheels based on the speed at which the vehicle is traveling. The engine transmission system typically includes a clutch mechanism which may engage and disengage these gears. The clutch mechanism may be operated manually by the vehicle's driver, or automatically by the vehicle itself based on the speed at which the driver wishes to operate the vehicle.

In automatic transmission vehicles, a need arises for the vehicle to sense the position of the clutch for smooth, effective shifts between gears in the transmission and for overall effective transmission control. Therefore, a clutch-position sensing component for sensing the linear position of the clutch may be used by automatic transmission vehicles to facilitate gear shifting and transmission control.

Current clutch-position sensing components utilize magnetic sensors. One advantage to using magnetic sensors is that the sensor need not be in physical contact with the object being sensed, thereby avoiding mechanical wear between the sensor and the object. However, actual linear clutch measurement accuracy may be compromised when the sensor is not in physical contact with the sensed object because of a necessary gap or tolerance that exists between the sensor and the object. Moreover, current sensing systems addressing this problem use coils and certain application-specific integrated circuits which are relatively expensive.

U.S. Pat. No. 8,324,890 discloses a transmission clutch position sensor which includes two Hall sensors located at opposite ends of a flux concentrator outside the casing of the transmission to sense a magnetic field generated by a magnet attached to the clutch piston. To reduce sensitivity to magnet-to-sensor gap tolerances, a ratio of the voltage of one Hall sensor to the sum of the voltages from both Hall sensors is used to correlate to the piston and, hence, clutch position.

For purposes of this application, the term “coupling” should be interpreted to include clutches or brakes wherein one of the plates is drivably connected to a torque delivery element of a transmission and the other plate is drivably connected to another torque delivery element or is anchored and held stationary with respect to a transmission housing. The terms “coupling”, “clutch” and “brake” may be used interchangeably.

### SUMMARY OF EXAMPLE EMBODIMENTS

One object of at least one embodiment of the present invention is to provide a non-hydraulic electromechanical system and an overrunning coupling and control assembly using the system wherein rotary motion about a first axis is converted to linear motion which, in turn, is converted back to rotary motion about a second axis substantially perpendicular to the first axis via cam action.

In carrying out the above object and other objects of at least one embodiment of the present invention, an electromechanical system for controlling the operating mode of a selectable clutch assembly is provided. The system includes a control member mounted for controlled rotation about a first axis and a bi-directional, electrically-powered actuator assembly including an output member coupled to the control member for selective, small-displacement, control member angular rotation about the first axis between different angular positions which correspond to different operating modes of the clutch assembly. The actuator assembly including a rotary output shaft, a threaded screw shaft coupled to the output shaft to rotate about a second axis substantially perpendicular to the first axis and a cam having a contour surface. The cam is threaded onto the screw shaft to move linearly along the second axis upon rotary movement of the screw shaft. The output member rides on the contour surface of the cam so that the output member rotates with the control member about the first axis. The system further includes control logic operative to determine a desired operating mode of the clutch assembly and to generate a corresponding position command signal and an actuator controller to controllably supply electrical power to the actuator assembly to move the control member to a desired angular position based on the position command signal.

The actuator controller may receive the position command signal from a remote electronic control unit through a bus.

The electronic control unit may be a transmission electronic control unit of a vehicle and the bus may be a vehicle-based bus.

The actuator assembly may include a DC motor having the output shaft for driving the control member.

The actuator controller may include a current sensor to monitor motor current draw. The control logic may control the DC motor based on the motor current draw.

The actuator assembly may include at least one non-contact position sensor to provide a position feedback signal as a function of the position of the cam along the second axis. The control logic may control the DC motor based on the position feedback signal.

Each sensor may include at least one magnetic or ferromagnetic magnet mounted for movement with the cam and at least one magnetic field sensing element disposed adjacent and stationary with respect to the at least one magnet for sensing magnetic flux to produce the position feedback signal.

Each magnetic field sensing element may be a Hall Effect sensor.

The cam may be back-drivable on the screw shaft. The system may further include a return biasing member to exert a biasing force on the cam to return the cam to a position on the screw shaft which corresponds to a safe clutch mode when the actuator assembly is de-energized.

The cam may be non-back drivable on the screw shaft.

The system may further include a latching mechanism to prevent the cam from moving linearly on the screw shaft.

The latching mechanism may include a latching solenoid.

The output member may include an actuator pin or arm coupled to the control member.

The contour surface may be defined by a groove which receives and retains a free end portion of the output member therein.

The groove may have end portions and an intermediate portion between the end portions. The end portions may provide an anti-backlash feature.

The control member may be a control or selector plate rotatable about the first axis.

The control member may have at least one opening which extends completely therethrough.

The controller may include a boost circuit to enable the controller to provide electrical power to the actuator assembly above nominal input power normally available from a battery of the vehicle to boost output torque and speed of the actuator assembly.

The boost circuit can also serve as an energy storage device in order to actuate the clutch in the event of loss of the vehicle's battery power (i.e. 12 volt power); this could serve as a fail safe mechanism for the mechanically latching design.

Further in carrying out the above object and other objects of at least one embodiment of the present invention, an overrunning coupling and electromechanical control assembly is provided. The assembly includes a coupling subassembly including first and second coupling members having first and second coupling faces, respectively, in close-spaced opposition with one another, at least one of the members being mounted for rotation about a first axis. The assembly further includes a control member mounted for controlled rotation about the first axis between the coupling faces and a bi-directional, electrically-powered actuator subassembly including an output member coupled to the control member for selective, small-displacement, control member angular rotation about the first axis between different angular positions which correspond to different operating modes of the coupling subassembly. The actuator subassembly includes a rotary output shaft, a threaded screw shaft coupled to the output shaft to rotate about a second axis substantially perpendicular to the first axis and a cam having a contour surface. The cam is threaded onto the screw shaft to move linearly along the second axis upon rotary movement of the screw shaft. The output member rides on the contour surface of the cam so that the output member rotates with the control member about the first axis. The assembly also includes control logic operative to determine a desired operating mode of the coupling subassembly and to generate a corresponding position command signal. An actuator controller controllably supplies electrical power to the actuator subassembly to move the control member to a desired angular position based on the position command signal.

The actuator controller may receive the position command signal from a remote electronic control unit through a bus.

The electronic control unit may be a transmission electronic control unit of a vehicle and the bus may be a vehicle-based bus.

The actuator subassembly may include a DC motor having the output shaft for driving the control member.

The actuator controller may include a current sensor to monitor motor current draw. The control logic may control the DC motor based on the motor current draw.

The actuator subassembly may include at least one non-contact position sensor to provide a position feedback signal as a function of the position of the cam along the second axis. The control logic may control the DC motor based on the position feedback signal.

Each sensor may include at least one magnetic or ferromagnetic magnet mounted for movement with the cam and at least one magnetic field sensing element disposed adjacent and stationary with respect to the at least one magnet for sensing magnetic flux to produce the position feedback signal.

Each magnetic field sensing element may be a Hall Effect sensor.

The cam may be back-drivable on the screw shaft and the assembly may further include a return biasing member to exert a biasing force on the cam to return the cam to a position on the screw shaft which corresponds to a safe coupling mode when the actuator subassembly is de-energized.

The cam may be non-back drivable on the screw shaft.

The assembly may further include a latching mechanism to prevent the cam from moving linearly on the screw shaft.

The latching mechanism may include a latching solenoid.

The output member may comprise an actuator pin or arm coupled to the control member.

The contour surface may be defined by a groove which receives and retains a free end portion of the output member therein.

The groove may have end portions and an intermediate portion between the end portions. The end portions may provide an anti-backlash feature.

The control member may be a control or selector plate rotatable about the first axis.

The assembly may further include a locking member disposed between the coupling faces of the coupling members. The locking member may be movable between first and second positions. The control member may be operable to control position of the locking member.

The locking member may be a reverse strut.

The control member may have at least one opening which extends completely therethrough to allow the locking member to extend therethrough to the first position of the locking member in a control position of the control member.

The controller may include a boost circuit to enable the controller to provide electrical power to the actuator subassembly above nominal input power normally available from a battery of the vehicle to boost output torque and speed of the actuator subassembly.

The boost circuit can also serve as an energy storage device in order to actuate the clutch in the event of loss of the vehicle's battery power (i.e. 12 volt power); this could serve as a failsafe mechanism for the mechanically latching design.

One of the coupling members may include a notch plate and the other of the coupling members may include a pocket plate.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### BRIEF DESCRIPTION OF THE DRAWINGS

FIGS. 1a-1c are schematic views, partially broken away and in cross section, of a control member or element with associated struts and its control apparatus of the prior art in the form of an actuating shift valve or piston (latching mechanism) in different control positions in the different views;

FIG. 2 is an exploded perspective view of an overrunning coupling or clutch assembly constructed in accordance with at least one embodiment of the present invention;

FIG. 3 is a schematic view of a motor operating point triangle which shows the interrelationship of electric motor output speed, power consumption and output torque;

FIG. 4 is a schematic view of a nut or cam threaded on a lead screw or screw shaft and showing an exaggerated cam groove profile or contour surface having a pair of “parking spots” at opposite ends of the groove;

FIG. 5 is a view, partially broken away, of a pair of screw shafts, one of which has a steep (small) lead angle and the other of which has a larger lead angle;

FIG. 6 is a top plan view, partially broken away, of a first embodiment of parts of an electromechanical system for controlling the operating mode or state of a selectable clutch assembly generally of the type shown in FIG. 2;

FIG. 7 is a top plan view, partially broken away, of a second embodiment of parts of the system;

FIG. 8 is a top plan view, partially broken away, of the third embodiment of parts of the system;

FIG. 9 is a block diagram schematic view of a motor controller with a failsafe boosting power circuit which communicates to the transmission controller via a CAN interface;

FIG. 10 is a detailed circuit diagram of the current failsafe power circuit of FIG. 9;

FIG. 11 is a view, similar to the view of FIG. 9, but showing a relatively simple controller for a back drivable actuator assembly wherein PWM and direction command outputs from the transmission controller are shown;

FIG. 12 is a view, similar to the view of FIG. 11, but showing a boost circuit in a back drivable actuator controller;

FIG. 13 is a block diagram view of a TECU, a power switching and supply circuit, a motor and one or more sensors wherein the TECU directly controls the motor's direction while indirectly powering the motor and monitors the position of the actuator via the Hall Effect sensor(s); and

FIG. 14 is a schematic block diagram of a controller power stage including a high side switch and a reverse polarity switch similar to FIG. 13; FIG. 14 shows an alternate control method where an external TECU controls the actuator via the circuit in FIG. 14; FIG. 13 shows a relay-based, cost-effective solution; FIG. 14 shows a solid state implementation that could be more effectively integrated into a power control module or external actuator controller circuit board.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

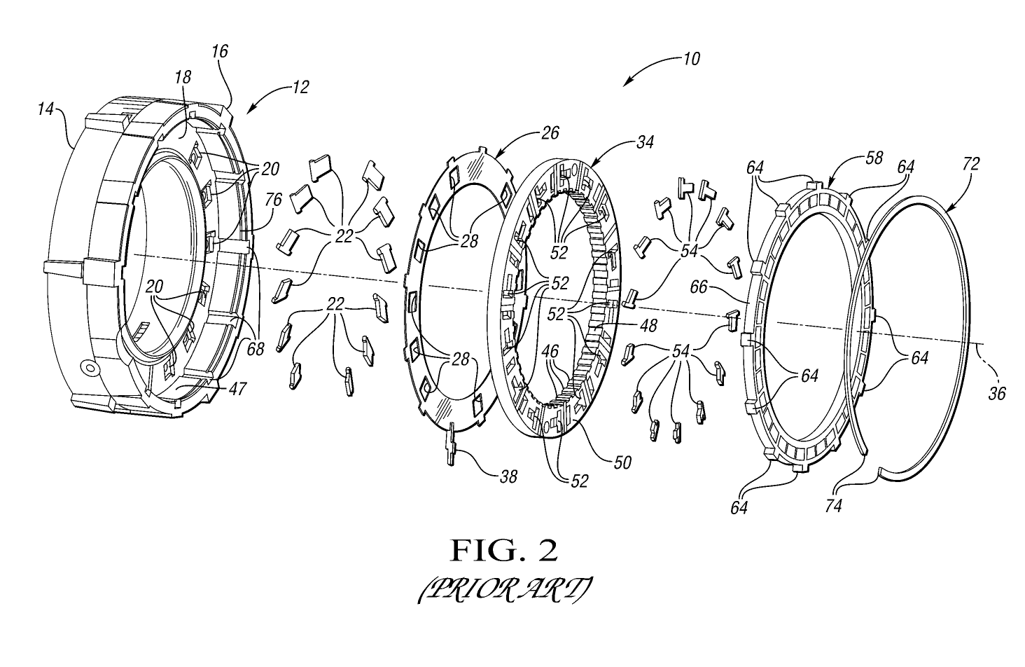

Referring again to the drawing figures, FIG. 2 is an exploded perspective view of an overrunning clutch or coupling assembly, generally indicated at 10, and constructed in accordance with at least one embodiment of the present invention. However, it is to be understood that the present invention can be utilized with a wide variety of selectable clutches, such as clutches having three or more operating modes or states. In fact, the present invention may be used with controllable mechanical diodes (CMDs) having an infinite number of operating modes or mechanical states.

As described in U.S. Pat. No. 8,602,187, and published U.S. patent application No. 2014/0190785, both assigned to the assignee of the present application, the assembly 10 includes an annular reverse pocket plate or first outer coupling member, generally indicated at 12. An outer axially-extending surface 14 of the plate 12 has external splines 16 for coupling the plate 12 to the inner surface of a transmission case (not shown). An inner radially extending surface or coupling face 18 of the plate 12 is formed with spaced pockets 20 in which reverse struts 22 are pivotally biased outwardly by coil springs (not shown) disposed in the pockets 20 under their respective struts 22. Preferably, twelve reverse struts 22 are provided. However, it is to be understood that a greater or lesser number of reverse struts 22 may be provided.

The assembly 10 also includes a control member or element in the form of a selector slide plate, generally indicated at 26, having a plurality of spaced apertures 28 extending completely therethrough to allow the reverse struts 22 to pivot in their pockets 20 and extend through the apertures 28 to engage spaced locking formations or ramped reverse notches (not shown) formed in a radially extending surface or coupling face of a forward or inner pocket plate or coupling member, generally indicated at 34, when the plate 26 is properly angularly positioned about a common central rotational first axis 36 by an output member in the form of an actuator pin or arm 38. The pin 38 is coupled or secured to the plate 26 to move therewith.

The pin 38 may extend through a notch or elongated slot formed through a wall or wall portion of an outer circumferential end wall of the plate 12 as shown in U.S. Pat. No. 8,602,187. The wall may be a common wall separating and shared by the first coupling member 12 and a housing of the control system. The elongated slot may extend between and thereby communicate an inner surface of the housing and an inner surface of the wall of the first coupling member 12. The pin 38 may move in the slot between different use positions to cause the plate 26 to slide or shift between its control positions to alternately cover or uncover the struts 22 (i.e., to engage or disengage the reverse struts 22, respectively).

The plate 34 comprises a splined ring having internal splines 46 formed at its inner axially extending surface 48. A radially extending surface 50 or coupling face spaced from the other coupling face (not shown) of the plate 34 has a plurality of spaced pockets 52 formed therein to receive a plurality of forward struts 54 therein which are pivotally biased by corresponding coil springs (not shown). Preferably, fourteen forward struts 54 are provided. However, it is to be understood that a greater or lesser number of forward struts 54 may be provided.

The assembly 10 may also include a second outer coupling member or notch plate, generally indicated at 58, which has a plurality of locking formations, cams or notches (not shown) formed in a radially extending surface or coupling face (not shown) thereof by which the forward struts 54 lock the forward plate 34 to the notch plate 58 in one direction about the axis 36 but allow free-wheeling in the opposite direction about the axis 36. The notch plate 58 includes external splines 64 which are formed on an outer axial surface 66 of the plate 58 and which are received and retained within axially extending recesses 68 formed within the inner axially extending surface 47 of the outer circumferential end wall of the plate 12.

The assembly 10 may further include a snap ring, generally indicated at 72, having end portions 74 and which fits within an annular groove 76 formed within the inner surface 47 of the end wall of the plate 12 to hold the plates 12, 26, 34 and 58 together and limit axial movement of the plates relative to one another.

The pin 38 has a control position to disengage the reverse struts 22. In one embodiment, a pin 38 is rotated about 7° in a forward overrun direction about the axis 36 to rotate the selector plate 26 to, in turn, allow the reverse struts 22 to move from their disengaged position in their pockets 20 to their engaged position with the notches (not shown) of the plate 34.

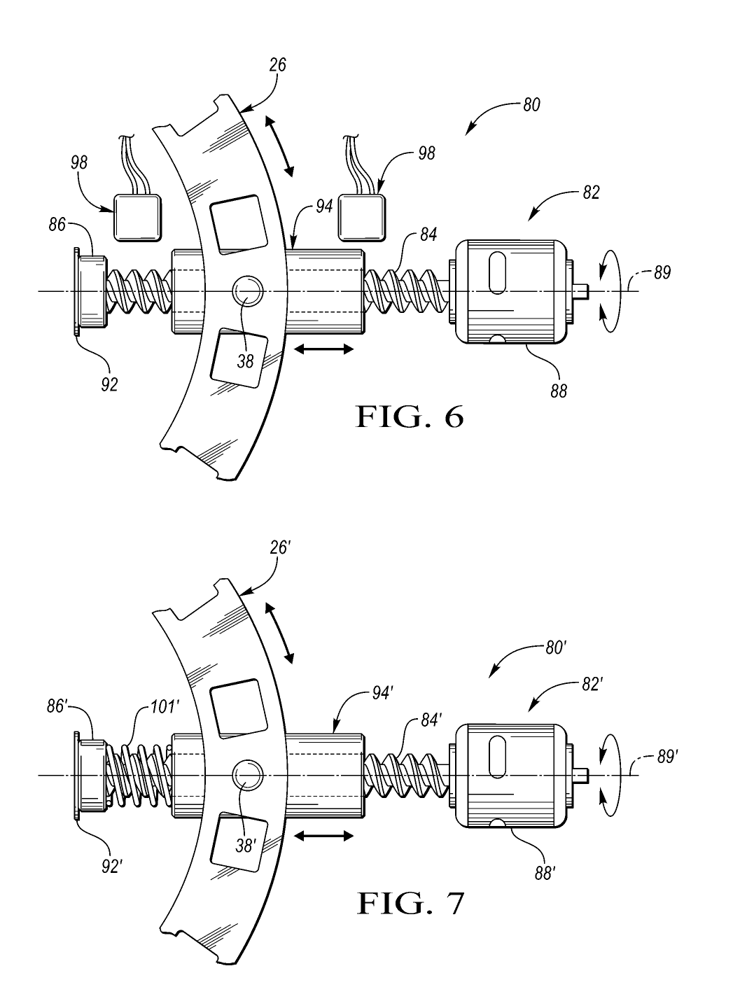

In three disclosed embodiments, parts of an electromechanical system for controlling the operating mode or state of the selectable clutch assembly 10 is generally indicated at 80, 80′ and 80″ in FIGS. 6, 7 and 8, respectively, wherein parts of the second embodiment which perform the same or similar function as the parts of the first embodiment have the same reference number but a single prime designation and wherein parts of the third embodiment which perform the same or similar function as the parts of the first two embodiments have the same reference number but a double prime designation.

Parts of the system 80 of the first embodiment (i.e., FIG. 6) includes a bi-directional, electrically-powered, actuator assembly, generally indicated at 82, coupled to the control member or plate 26 for selective, small-displacement, control member or plate movement between first and second positions which correspond to first and second operating modes of the clutch assembly 10, respectively. As previously mentioned, more than two positions may be provided such as three positions of a three state CMD. In fact, at least in theory, an infinite number of states can be supported.

The actuator assembly 82 holds the control member 26 in the desired commanded position after electrical power to the actuator assembly 82 has been purposefully terminated. In the first embodiment of FIG. 6, a latch mechanism of the assembly 82 may include a self-locking threaded screw shaft, generally indicated at 84, coupled to the output shaft of a bi-directional D.C. motor or brushed DC motor 88. The screw shaft rotates about a second axis 89 substantially perpendicular to the first axis 36.

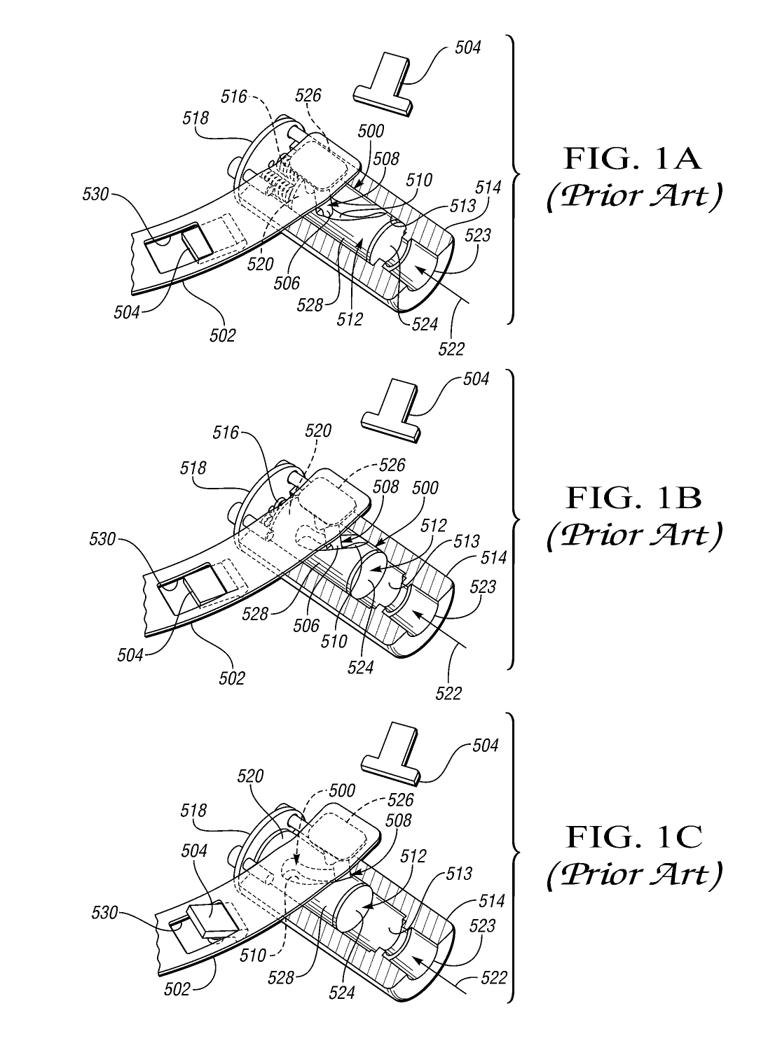

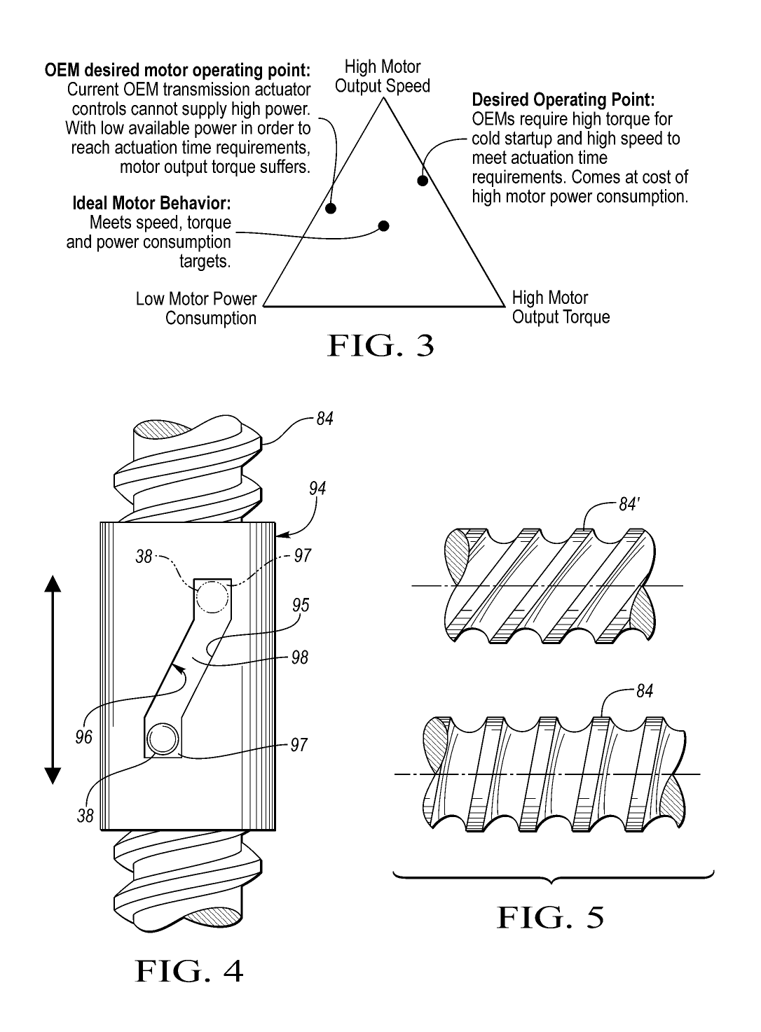

The lead screw 84 provides high torque multiplication while still packaging in available envelopes. The lead screw actuator assembly 82 packages as a retrofit into existing space for other actuator designs (see, FIGS. 1a-1c). The lead screw actuator assembly 82 is aligned similarly to the hydraulic actuator valve. The increased mechanical advantage of the lead screw 84 presents several advantages over direct actuation methods:
i. Specifically, by selecting a steep (small) enough lead angle (i.e., lower portion of FIG. 5), the system 80 can be made non-back drivable. Non-back drivable is defined as the nut 94 not being able to be moved due to external forces on the nut 94. The nut 94 can only move due to the rotation of the lead screw 84. This allows for a latching actuator design.
ii. The increased torque multiplication of the lead screw 84 can allow for the DC brushed drive motor 88 to be decreased in size and cost. FIG. 3 shows a motor operating point triangle. The idea of the operating triangle is that it is very difficult for DC brushed motors to simultaneously satisfy high output speed, high output torque and low power consumption. In order to meet the OEM's requirements for low actuation time (high motor output speed) and power consumption, the required motor output torque needs to be sacrificed or decreased. The lead screw 84 provides a higher ratio of torque multiplication than other simple gear reductions, reducing the motor's required output torque. With a smaller torque requirement, a smaller DC motor can be selected. Smaller motors typically provide higher output speeds and lower power consumption as desired by the OEM's.

In the first embodiment of FIG. 6, the actuator assembly 82 includes an output member in the form of the actuator arm or pin 38. The screw shaft 84 is supported for rotary motion by a bushing 86. A thrust washer 92 is provided at one end of the screw shaft 84 to absorb thrust loads.

The assembly 82 also includes a nut or a cam generally indicated 94. The cam 94 has a contour surface (not shown in FIG. 6 but shown at 95 in FIG. 4 for simplicity). The cam 94 is threaded onto the screw shaft 84 to move linearly along the second axis 89 upon rotary movement of the screw shaft 84. The output member or arm 38 rides on the contour surface 95 of the cam 94 so that the output member or arm 38 rotates with the control member 26 about the first axis 36.

As shown in FIG. 4, the cam surface 95 is preferably defined by a groove 96 with opposite end portions 97 and an intermediate portion 99 between the end portions 97. The end portions 97 provide “parking spots” at the ends of the cam groove 96.

In other words, the lead screw nut 94 includes a cam groove 96 to interface the nut 94 to the actuator arm 38. The groove 96 traps the actuator arm 38, translating the linear motion of the nut 94 into planar rotary motion of the arm 38 and the selector plate 26. In addition, geometry of the groove 96 creates two “parking spots” for the actuator arm 38. Each “parking spot” is included so that the internal forces of the clutch assembly on the selector plate 26 and actuator arm 38 cannot result in the actuator arm 38 inadvertently moving in the groove 96 causing the lead nut 94 to move linearly. This is especially significant in failsafe applications where the lead screw nut 94 is back drivable. The “parking spots” on either end of the cam 94 prevent the internal forces of the clutch assembly from causing an inadvertent change of clutch assembly mode or state.

The addition of the lead screw nut's worm cam groove 96 makes the actuator system very insensitive to backlash between the lead screw 84 and nut 94. With the actuator arm 38 in a “parking spot” at either end of the nut's groove profile 96, the arm 38 is less sensitive to small linear movements of the nut 94. As a result, costly anti-backlash features can be left out of the lead screw 84 and nut or cam 94.

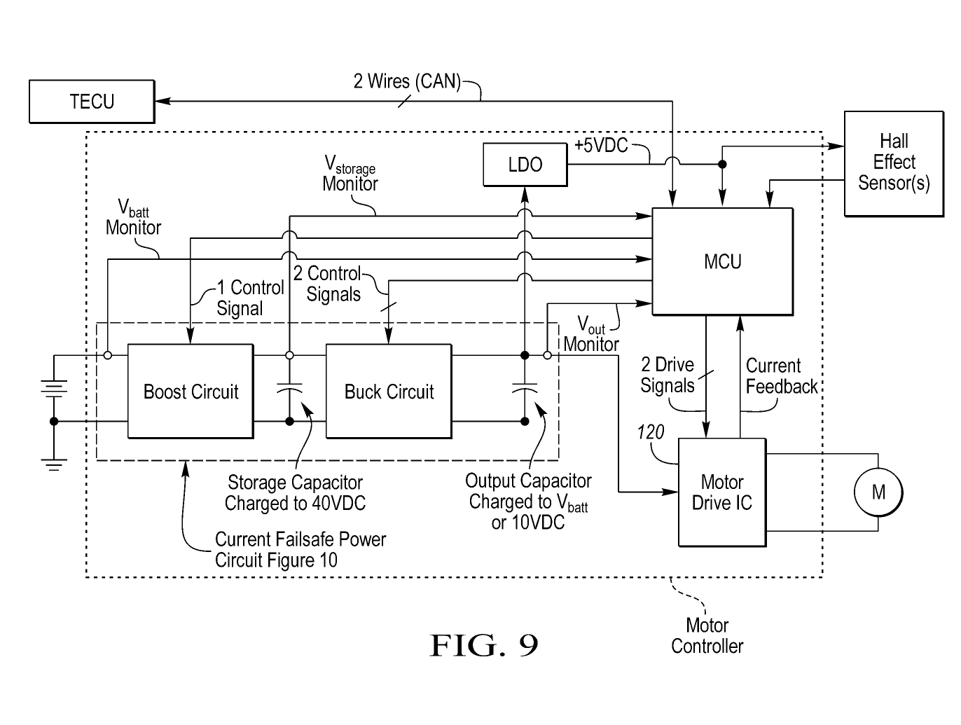

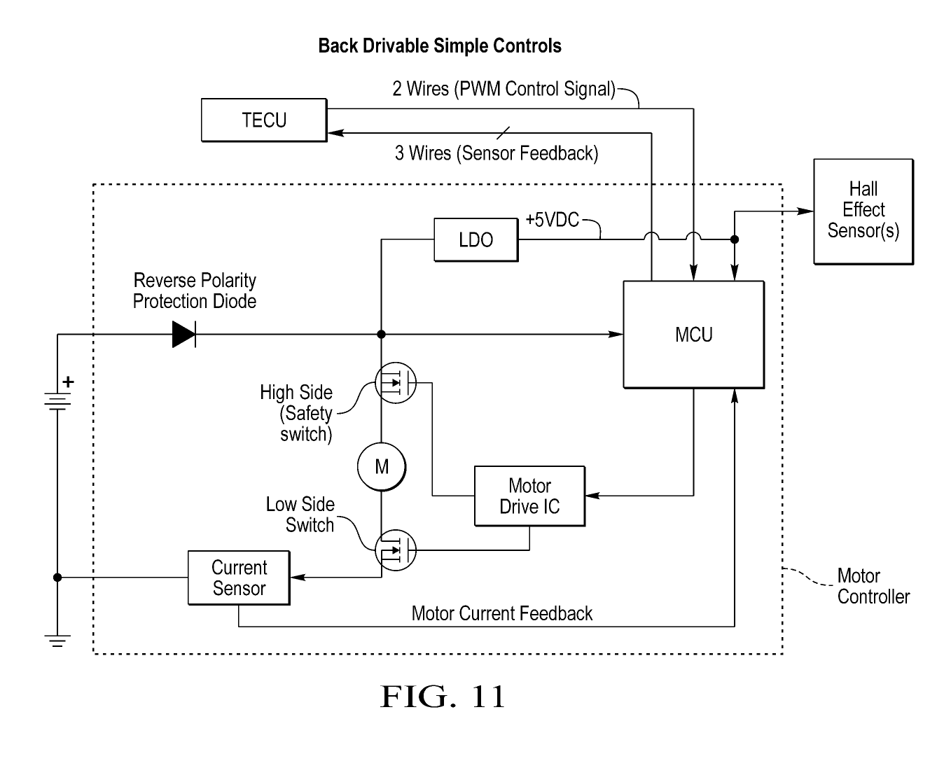

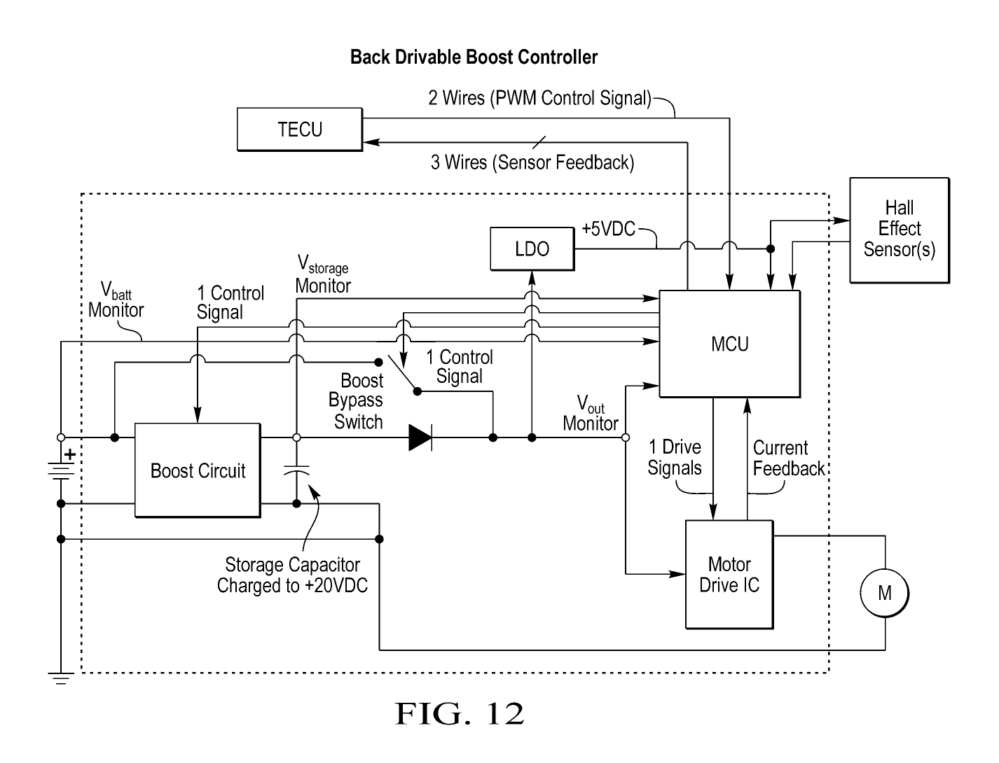

The actuator assembly 82 also preferably includes at least one non-contact position sensor to provide a position feedback signal as a function of the position of the cam 94. Each sensor may include at least one magnetic or ferromagnetic magnet (not shown) mounted for movement with the cam 94 and at least one and preferably two magnetic field sensing elements 98 disposed adjacent and stationary with respect to the at least one magnet for sensing magnetic flux to produce position feedback signals to a controller (FIGS. 9, 11 and 12). Each magnetic field sensing element 98 is preferably a Hall Effect sensor. Alternatively the sensor may comprise an inductive position sensor. The two digital sensors can be replaced with a single analog sensor or by monitoring current drawn by the motor 88 via a current sensor (FIG. 11).

Since the nut 94 of FIG. 6 is not back drivable (provides a latching function), no separate latching device is typically needed.

In the second embodiment of FIG. 7 the screw's lead angle is increased (i.e. upper part of FIG. 5) so that nut 94′ is back drivable and a return spring 101′ is added to return the nut 94′ to a safe clutch state or mode when the motor 88′ is de-energized. This feature:
adds passive, mechanical, failsafe functionality;
allows a customer to remove motor power when the clutch is torque locked, allowing the selector plate 26′ to partially return against the locked struts. Thus, improving the response time of the clutch when returning to safe (struts covered) state.

Directional control of the motor 88′ is not required as the system relies on the stored energy in the compressed return spring 101′ to return the system to a “strut-covered” condition. This dramatically simplifies the motor controller, removes potential failure modes and reduces controls cost.

A simple solid state switch version for such a back drivable motor controller is shown in FIG. 11:
1. includes high side protection to prevent inadvertent actuation during wire shorts;
2. can be implemented using electromechanical relays instead of solid state semiconductor devices shown therein for cost reasons.

A “boost” version of the motor controller of FIG. 11 is shown in FIG. 12. As shown therein, the transmission controller (TECU) applies a time varying, pulse width modulated control signal to the motor controller. Based on the duty cycle of the control signal, the motor controller either enters boosted mode or applies pulse width modulated power to the DC motor 88′.

The controller of FIG. 12 can determine (i.e. via motor current and/or sensor feedback) if the clutch is torque locked. Then the controller can decide to activate the boost circuit and utilize the stored energy of the storage capacitor to deliver high power to the motor in an attempt to disengage the clutch. It is to be understood that the ability to utilize the boosted power is not limited to the controller of FIG. 12 but could also be implemented in the controller of FIG. 9.

The advantages of the embodiment of FIG. 12 are numerous. DC brushed motors' output speed and torque is a function of the applied power. If the power is applied gradually, it is generally safe to temporarily exceed the nominal input power for the motor 88. Applying the higher input power results in higher motor output speed and torque. For low temperature conditions, there may be increased drag between the selector plate 26 and housing due to the presence of cold, high viscosity automatic transmission fluid. In order to deliver the increased torque necessary to break the selector plate 26 free from the viscous oil, a higher than usual amount of power is delivered to the motor 88 for a limited amount of time. The boost circuit of FIG. 12 generates and stores the higher voltage energy necessary to break the selector plate free. Under normal temperature conditions the boost circuit is bypassed to increase system efficiency. The boost circuit also has the advantage of limiting the instantaneous power draw from the battery of the vehicle, which is important as the battery's voltage level may be lower than usual due to the cold temperatures.

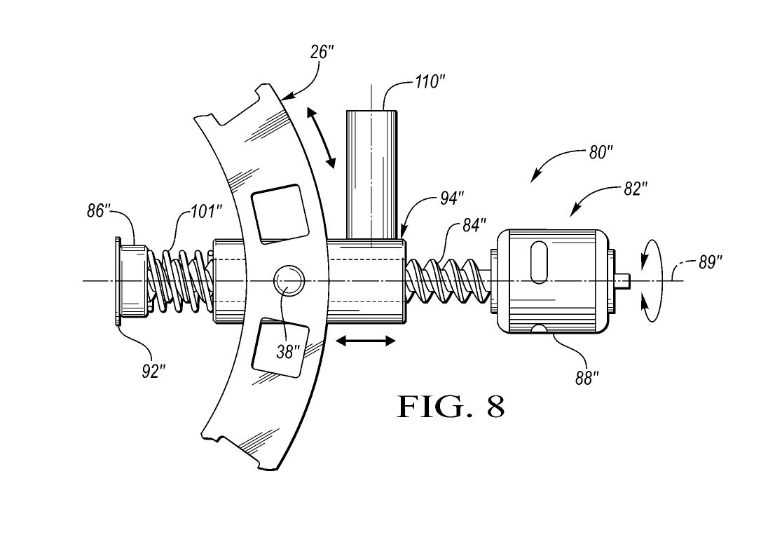

In the third embodiment of FIG. 8 (which is similar to the second embodiment), a latching mechanism in the form of a latching solenoid 110″ is provided substantially perpendicular to the cam 94″ that latches the cam 94″ in either clutch mode or state.

Preferably the latching solenoid 110″ is a push type and spring-returned so that upon power loss the armature of the solenoid 110″ retracts, allowing the cam's return spring 101″ to return the clutch to the safe state. An advantage of the use of the solenoid 110″ is reduced energy consumption (return solenoid verses lead screw motor) and ability to prevent unintended actuation in either clutch state.

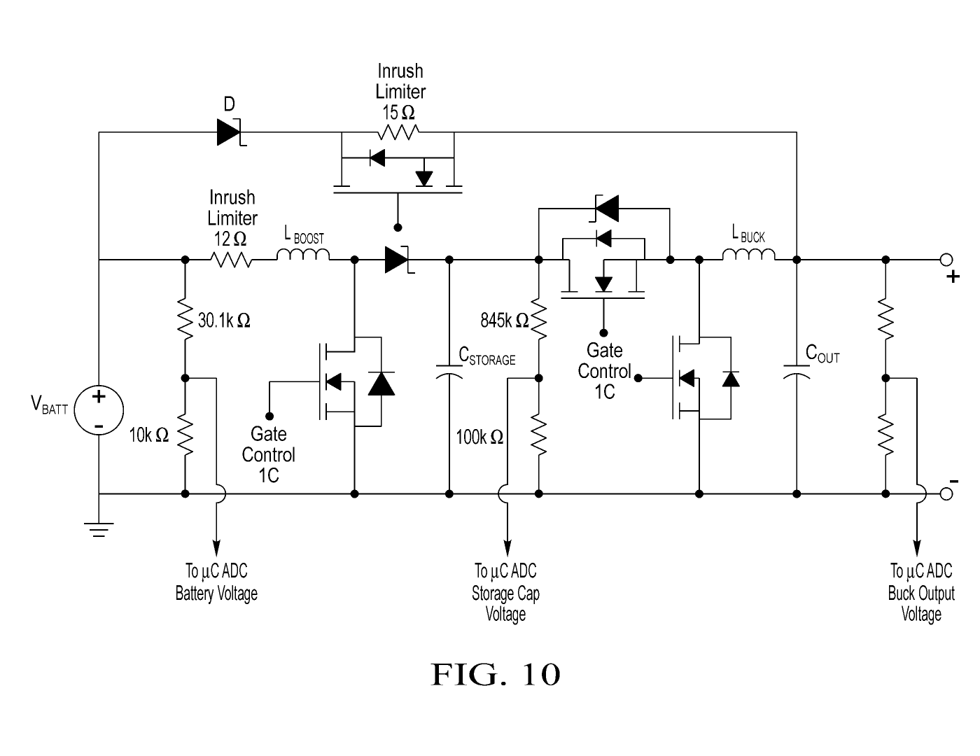

Referring to FIG. 12, the motor controller shown there is made failsafe by addition of the capacitive backup power source and independent controller. Referring to FIGS. 9 and 10, circuitry illustrated therein:
provides electric-based, failsafe behavior; and
allows voltage levels above battery potential to be applied to the motor for short durations to increase actuation force.

In summary, the electric motor 88″ rotates the lead screw or screw shaft 84″ which translates the motor's rotational motion into the nut's linear motion. The nut 94″ has a contour surface defined by a groove 96 that holds the actuator arm 38″ captive, converting the nut's linear motion into the rotary motion of the selector plate's actuator arm 38″. A bushing 86″ installed at the end of the lead screw 84″ allows the screw 84″ to rotate with low losses. In the event excessive selector plate forces are present, the thrust washer 92″ absorbs the thrust load.

A vehicle's transmission electronic control unit (TECU) provides and regulates the power to drive the motor (88, 88′ or 88″). The control circuitry of FIGS. 9-14 may be coupled to the motor (88, 88′ or 88″) so that bi-directional control of the motor is achieved. In some embodiments, the TECU decides which direction to drive the motor, sets a digital output accordingly and then turns on its VFS (variable force solenoid) output to drive the motor. Existing TECUs' have traditionally employed variable force solenoid valve control to manipulate the transmission's hydraulic control circuit to change clutch states. Electromechanical clutch actuation as provided in some embodiments herein repurposes the TECU's existing outputs in order to minimize cost and preserve a common TECU for both hydraulic and electromechanical clutch actuation schemes. The VFS outputs are typically unipolar, current controlled, pulse width modulated (PWM) driver circuits and can therefore only drive the bi-directional motor in a single direction. In order to provide a minimally invasive method for the existing TECU architecture to control the bi-directional motor, the control circuits of FIGS. 9-14 may be provided. Each control circuit or controller could be implemented or realized with discrete logic or a microcontroller depending on the system's requirements.

The TECU can either directly supply or indirectly control supply power to the controller. There is an advantage in the indirect control method as the controller's current consumption is not limited by the capabilities of the TECU. The TECU retains the ability to remove power to the controller.

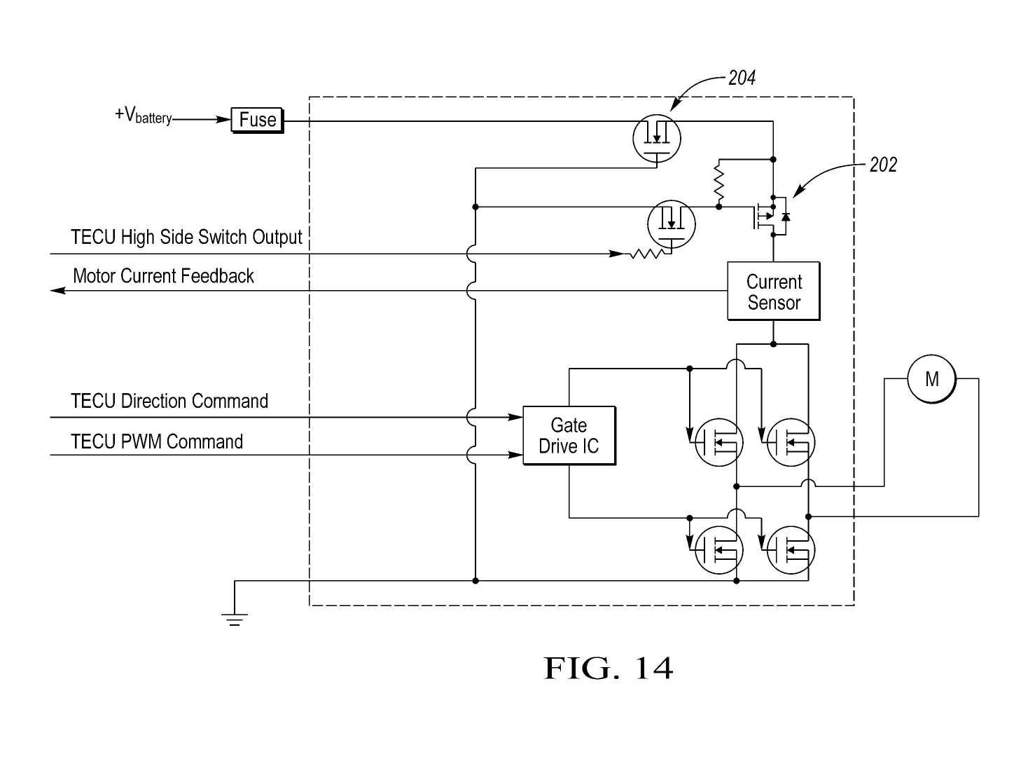

Referring now to FIG. 14, when it is desired to control power to the controller even when not directly powered by the TECU, the controller power stage of FIG. 14 can be provided. The controller may be directly connected to battery power by providing a high side switch 202 wherein the TECU can disable power to the controller during faults and/or when the vehicle is keyed off. The high side switch 202 provides a way to disconnect the motor if the MOSFET driven by the PWM command is stuck “on”.

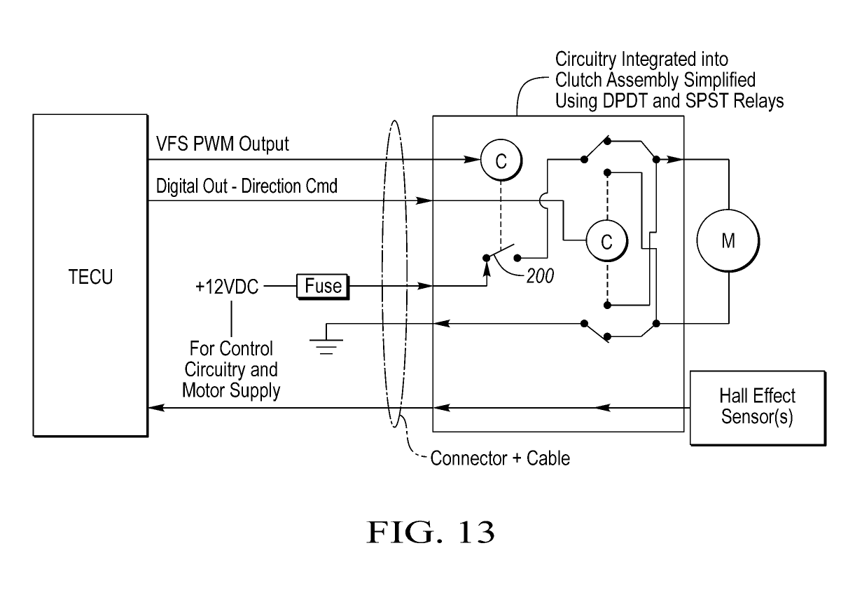

The TECU sets a high side output, sourcing battery voltage to the gate of a N-channel MOSFET. The N-channel MOSFET once turned on, grounds the gate of a P-channel MOSFET turning it on. The P-channel MOSFET provides power to the rest of the controller circuit. As an alternate implementation, the TECU's high side output can directly energize the coil of a N.O. relay. The relay contact supplies power to the rest of the circuit. FIG. 13 is a simplified implementation of the controller with cost advantages. FIG. 13 shows the power signal driving a MOSFET gate (shown as SPST relay coil). The MOSFET 200 then supplies current to the motor.

Still referring to FIG. 14, for devices directly connected to automotive battery power, protection circuitry 204 is provided to protect against damage resulting from improper installation of the vehicle battery (i.e. wrong polarity). A simple P-channel MOSFET 204 is connected to the circuitry before the high side switch 202. If the battery is connected with improper polarity, the MOSFET 204 will have a positive voltage at its gate relative to the drain and turn itself “off”. Under normal conditions, the drain will have positive battery voltage connected to it while the gate will have a ground potential thereby causing the MOSFET 204 to turn “on”.

FIGS. 11 and 12 have the PWM control signal. FIG. 9 has the CAN as bi-directional communication bus. Any of the controller concepts can be implemented with CAN or PWM based communication. By implementing a bi-directional communication bus, using any number of accepted protocols, between the TECU and the controller, status information and move commands can be exchanged.

The circuitry of FIGS. 11 and 12 allows the TECU to control both the direction and speed of the electric motor (88, 88′ or 88″) requiring only a single TECU PWM output. The controller interprets the PWM waveform generated by the TECU and decides the direction of the motor's rotation. In a sense, FIGS. 11 and 12 have bi-directional communication (just not on the same bus), the TECU sends via PWM and the controller passes back the motor current and sensor status via a combination of analog and digital voltage signals. A bi-directional communication bus, especially with CAN or LIN systems, has the implication that the bi-directional communication occurs on the same physical bus.

If desired, DPDT (Double pole, double throw) relays could be used in the control circuit and may be solid state switches. There are a number of ways that the switching of the motor leads in circuit 120 can be achieved: DPDT relays, discrete solid state switches or a full H-bridge module.

The system 80 (as well as the system 80′ and the system 80″) may include a microcontroller (i.e., MCU) including control logic which may alternatively be found within other circuitry in the motor controller of the system 80. Again, the motor controller typically receives command signals from the remote electronic control unit (TECU) over or through a vehicle-based bus.

FIG. 9 also shows a failsafe power circuit to controllably store electrical power and apply the stored electrical power to the motor drive IC or circuit 120 based on a failsafe position command signal in the event of a system failure such as communication or power failure as determined by the microcontroller (MCU). The motor drive IC 120 generates the power signals to the drive motor while the TECU remains in a supervisory role. The MCU could be replaced with a FPGA or a very extensive array of discrete modules. The failsafe power circuit can be designed without the low level diagnostics reporting to the TECU and then could receive actuation commands via digital outputs from the TECU and send high level status (i.e. sensor status or actuation controller is faulted) information back to the TECU via digital outputs on the actuation controller. Also, the failsafe actuation circuitry can be adapted to any electromechanical actuation scheme wherein mechanical latching occurs.

The MCU or microcontroller typically receives power and direction command signals from the TECU through a vehicle CAN bus. The MCU also receives various monitor, control and feedback signals to monitor different voltages within the power circuit to properly control the motor drive 120. The MCU receives one or more feedback signals from the Hall effect sensor(s) and a current feedback signal based on motor current. In turn, the MCU controls the operation of the boost circuit and the buck circuit of the power circuit as well as the motor drive 120.

An LDO (i.e. low dropout), DC linear voltage regulator regulates the voltage at the output capacitor and provides regulated voltage to the MCU and the Hall effect sensor(s).

The remote transmission ECU (TECU) typically has a microprocessor, called a central processing unit (CPU), in communication with a memory management unit (MMU). The MMU controls the movement of data among the various computer readable storage media and communicates data to and from the CPU. The computer readable storage media preferably include volatile and nonvolatile storage in read-only memory (ROM), random-access memory (RAM), and keep-alive memory (KAM). For example, KAM may be used to store various operating variables while CPU is powered down. The computer-readable storage media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by CPU in controlling the transmission or vehicle into which the transmission is mounted.

The computer-readable storage media may also include floppy disks, CD-ROMs, hard disks, and the like. CPU communicates with various sensors, switches and/or actuators directly or indirectly via an input/output (I/O) and actuators directly or indirectly via an input/output (I/O) interface or vehicle bus (i.e., CAN, LIN, etc.). The interface may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to CPU. Some controller architectures do not contain an MMU. If no MMU is employed, the CPU manages data and connects directly to ROM, RAM, and KAM coupled to the MMU or CPU depending upon the particular application.

The various components or functions of the motor controller of FIG. 9 may be implemented by the separate motor controller as illustrated, or may be integrated or incorporated into the transmission ECU, or other controller, depending upon the particular application and implementation. The MCU typically include the control logic to control the actuator assembly (82 or 82′ or 82″). The control logic may be implemented in hardware, software, or a combination of hardware and software.

The control logic is also operative to determine a system failure and to generate a failsafe position command or drive signal in the event of the system failure. The actuator assembly (82 or 82′ or 82″) moves the control member (26 or 26′ or 26″, respectively) to a failsafe position based on the failsafe position command signal to prevent inadvertent engagement of the clutch assembly 10. Ordinarily, the control logic determines a desired one of the possible positons of the control member or plate (26 or 26′ or 26″) based on the command signal received from the remote electronic control unit through the vehicle bus. The system failure may be an unexpected loss of electrical power to the actuator assembly (82 or 82′ or 82″).

The motor controller of FIG. 9 typically includes an energy storage device or power circuit (including the storage and output capacitors of FIGS. 9 and 10) to controllably store and supply the stored electrical power to the motor drive 120 and, in turn, to the DC motor (88 or 88′ or 88″) in the event of the unexpected loss of electrical power. The system failure may be a loss of communication of the MCU with the remote electronic control unit.

The circuit in FIG. 10 comprises backup or failsafe power circuitry for powering the motor and the MCU or microcontroller (through the LDO) in the event of loss of the vehicle's 12 VDC power supply. In normal operation, with the vehicle's 12 VDC present, the motor and the microcontroller's power will be sourced through the Schottky diode, D, at the top of the circuit of FIG. 10. The left hand side of the circuit of FIG. 9 is a boost converter or circuit that takes the vehicle's 12 VDC power and boost it to approximately 40 VDC and stores that energy in the storage capacitor. The Schottky diode, D, as well as a separate diode (not shown) at the input of the boost circuit helps protect against reverse polarity being supplied to the battery. After “key on” and the vehicle's 12 VDC power has stabilized, the microcontroller (i.e. MCU) turns on the boost or converter (at a gate control device) and runs the boost converter until the storage capacitor is charged to 40 VDC. Then the boost converter will turn off, only turning back on when the storage capacitor's voltage has dropped below a preprogrammed threshold as monitored and determined by the MCU.

On the right hand side of the power circuit is a buck converter or circuit that uses the storage capacitor as its input. In the event of vehicle power loss, the microcontroller (i.e. MCU) will turn on the buck converter (at a gate control device) that will output the necessary voltage (at Cₒᵤₜ) to operate the DC motor via the motor drive 120 and keep the microcontroller on via the LDO long enough to return the control member back to a safe (i.e. failsafe) position or condition.

As will be appreciated by one of ordinary skill in the art, one or more memory devices within the transmission ECU and/or the motor controller may store a plurality of activation schemes for the control member or plate 26 or 26′ or 26″ and may represent any one or more of a number of known processing strategies such as event-driven, interrupt-driven, multi-tasking, multi-threading, and the like. As such, various steps or functions may be performed in sequence, in a modified sequence, in parallel, or in some cases omitted. Likewise, the order of operation or processing is not necessarily required to achieve the objects, features, and advantages of the invention, but is provided for ease of illustration and description.

Although not explicitly illustrated, one of ordinary skill in the art will recognize that one or more of the illustrated steps or functions may be repeatedly performed depending upon the particular application and processing strategy being used. Preferably, the control logic is implemented primarily in software executed by a microprocessor-based controller or the microcontroller (i.e. MCU). Of course, the control logic may be implemented in software, hardware, or a combination of software and hardware depending upon the particular application. When implemented in software, the control logic is preferably provided in a computer-readable storage medium having stored data representing instructions executed by a computer to control the control member (26 or 26′ or 26″) of the system (80 or 80′ or 80″, respectively) through the actuator assembly (82 or 82′ or 82″, respectively). The computer-readable storage medium or media may be any of a number of known physical devices which utilize electric, magnetic, and/or optical devices to temporarily or persistently store executable instructions and associated calibration information, operating variables, and the like.

In one example embodiment, the control member or plate (26, 26′ or 26″) is electromechanically driven by the actuator assembly including a rotary actuator such as the DC motor (88, 88′ or 88″ and associated transmission in the form of the lead screw (84, 84′ or 84″) or the like. The DC motor (88, 88′ or 88″) may be, for example, a brushed or brushless DC servomotor, the operation of which is controlled by the motor controller via a motor drive or driver (such as an H bridge motor driver) within the motor controller. The brushed or brushless motor may have its rotary speed and position controlled by pulse width modulation (PWM) control so that the position of the control member or plate (26, 26′ or 26″) is adjusted.

The motor controller outputs motor drive commands to the DC motor (88, 88′ or 88″) based on outputs from the Hall effect sensor(s) 98, 98′ or 98″, current feedback from the DC motor and/or decoded commands from the transmission ECU. The motor controller controls the DC motor through the motor drive 120 of the motor controller so that the angular position of the control member is changed. In other words, the transmission ECU outputs servomotor drive commands to the motor controller which controls the DC motor (88, 88′ or 88″) and, through its transmission, the selector plate (26, 26′ or 26″).

The TECU and the motor controller are connected via the vehicle bus such as a local interconnect network (LIN or CAN) line or bus capable of two-way communications. LIN is one of many possible in-vehicle local area network (LAN) communications protocols. A power line and a ground line may be provided between the TECU and the motor controller. The motor controller typically includes a transceiver interface within the MCU, a microprocessor and its control logic within the MCU, and the motor drive or driver 120, and an electrical power source (provided by the failsafe power circuit). The motor controller may be integrated or physically coupled with the DC motor (88, 88′ or 88″) in the clutch housing, while the TECU is provided some distance away from the clutch housing.

The power source or circuit of the motor controller supplies electric power of predetermined voltage levels to the MCU and the Hall Effect sensor(s) through the LDO and the motor drive or driver. The transceiver within the MCU is a communications interface circuit connected to the network or vehicle bus for communications and operates as a receiver section for the MCU and a transmitter section back to the TECU. The motor driver typically includes the driver circuit for driving the DC motor.

The Hall Effect sensor(s) are typically provided near or coupled to or near the cam (94, 94′ or 94″) (which mechanically couples the output shaft of the motor (88, 88′ or 88″) with the selector plate 26, 26′ or 26″, respectively) and may be driven in synchronism with the rotation of the DC motor to generate pulse signals which are received by the MCU.

The MCU of the motor controller typically includes a memory and may be configured as a conventional microcomputer including a CPU, a ROM, a RAM and the like or as a hardwired logic circuit.

The TECU and the motor controller may perform data communications regularly through the LIN or CAN bus. In such data communications, the motor controller may transmit state data indicating the state of the DC motor to the TECU. The state data may include a present rotation position of the DC motor, that is, count value of a rotation position counter stored in a memory of the MCU of the motor controller.

The TECU and/or the motor controller may confirm the present rotation position of the DC motor. The TECU then may set a target stop position of the DC motor based on various states detected by non-contact position sensor(s) commands and the present rotation position of the DC motor, and generates a DC motor drive command for driving the DC motor to one or more target stop positions. Such a position sensor provides a position feedback signal as a function of the position of the control member or plate (26, 26′ or 26″). Each sensor may include at least one magnetic or ferromagnetic magnet mounted for movement on the cam (94, 94′ or 94″) of the actuator assembly and at least one magnetic field sensing element 98 disposed adjacent and stationary with respect to the at least one magnet in the clutch housing, for example, for sensing magnetic flux to produce the position feedback signal. Each magnetic field sensing element is preferably a Hall Effect sensor.

When the logic circuit of the MCU of the motor controller receives motor drive commands from the TECU through its transceiver, it transmits drive commands or signals to the motor drive or driver 120 to rotate the DC motor in the forward or reverse direction so that the DC motor stops at a desired target stop position.

If the detected, present rotation position of the DC motor arrives at the target stop position, that is, the present position coincides with the target stop position, the logic circuit of the MCU transmits a stop command to the motor driver for stopping the DC motor.

In communicating with the TECU, the motor controller may transmit to the TECU the present rotation position of the servomotor detected based on the signals of the sensor(s) while the DC motor is in rotation. The motor controller may also transmit to the TECU stop data indicating the stop of the DC motor when the DC motor has stopped at its target stop position. The TECU typically checks if the data received from the motor controller includes the stop data therein. If the stop data is included, the TECU determines that the DC motor has stopped at its target stop position.

If the stop data indicating the stop of the DC motor is not included, the TECU typically compares the present rotation position of the DC motor received and the present rotation positons of the DC motor received in the previous communications to check whether the present rotation position has changed.

In view of the above, at least one embodiment of the system utilizes a bidirectional DC motor, a threaded screw shaft, one or more proximity sensors, a cam having a contour surface, a motor drive, a microcontroller, and a capacitor energy storage and supply power circuit to do the following:
a. actuate a multi-position, selectable, mechanical diode, selector plate and provide mechanical holding force via the screw shaft (FIG. 6) or latching solenoid (FIG. 8) or other transmission interface that requires no or little continuous electrical energy consumption to maintain;
b. utilizes one or more proximity sensors (FIG. 6) to determine actual position of the selector plate;
c. communicate with customer's transmission electronic control unit via a CAN or other vehicle bus to receive actuation commands and send selector plate position status and system diagnostic data; and
d. provide an electronic failsafe that will return the clutch assembly to a safe position or state in the event of vehicle power loss or loss of communications with the transmission electronic control unit.

The electrical selectable, mechanical diode, actuation system of FIG. 7 utilizes a mechanical means of return (i.e. spring 101′) so that the system returns to an initial state in the event of loss of power to the actuator. At least one embodiment of the present invention returns the selector plate to its initial, failsafe position in the event of vehicle power loss.

In at least one embodiment of the present invention, the proposed mechanisms of FIGS. 6, 7 and 8 when coupled with controls such as in FIGS. 9 and 12 provide the ability to disengage the clutch when the locking elements are under load. This provides functionality which allows the controllable mechanical diode (CMD) to behave similar to a traditional clutch pad. Any of the mechanisms of FIG. 6, 7 or 8 are designed such that forces internal to the clutch cannot charge the state of the actuation system. This is particularly important to cold weather operation as noted above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electromechanical system for controlling the operating mode of a selectable clutch assembly, the system comprising:
a control member mounted for controlled rotation about a first axis;
a bi-directional, electrically-powered actuator assembly including an output member coupled to the control member for selective, small-displacement, control member angular rotation about the first axis between different angular positions which correspond to different operating modes of the clutch assembly, the actuator assembly including a rotary output shaft, a threaded screw shaft coupled to the output shaft to rotate about a second axis substantially perpendicular to the first axis and a cam having a contour surface, the cam being threaded onto the screw shaft to move linearly along the second axis upon rotary movement of the screw shaft, the output member riding on the contour surface of the cam so that the output member rotates with the control member about the first axis;
control logic operative to determine a desired operating mode of the clutch assembly and to generate a corresponding position command signal; and
an actuator controller to controllably supply electrical power to the actuator assembly to move the control member to a desired angular position based on the position command signal.

2. The system as claimed in claim 1, wherein the actuator controller receives the position command signal from a remote electronic control unit through a bus.

3. The system as claimed in claim 2, wherein the electronic control unit is a transmission electronic control unit of a vehicle and the bus is a vehicle-based bus.

4. The system as claimed in claim 1, wherein the actuator assembly includes a DC motor having the output shaft for driving the control member.

5. The system as claimed in claim 4, wherein the actuator controller includes a current sensor to monitor motor current draw, the control logic controlling the DC motor based on the motor current draw.

6. The system as claimed in claim 4, wherein the actuator assembly includes at least one non-contact position sensor to provide a position feedback signal as a function of the position of the cam along the second axis, the control logic controlling the DC motor based on the position feedback signal.

7. The system as claimed in claim 6, wherein each sensor includes at least one magnetic or ferromagnetic magnet mounted for movement with the cam and at least one magnetic field sensing element disposed adjacent and stationary with respect to the at least one magnet for sensing magnetic flux to produce the position feedback signal.

8. The system as claimed in claim 7, wherein each magnetic field sensing element is a Hall effect sensor.

9. The system as claimed in claim 1, wherein the cam is back-drivable on the screw shaft and wherein the system further comprises a return biasing member to exert a biasing force on the cam to return the cam to a position on the screw shaft which corresponds to a safe clutch mode when the actuator assembly is de-energized.

10. The system as claimed in claim 1, wherein the cam is non-back drivable on the screw shaft.

11. The system as claimed in claim 9, further comprising a latching mechanism to prevent the cam from moving linearly on the screw shaft.

12. The system as claimed in claim 11, wherein the latching mechanism includes a latching solenoid.

13. The system as claimed in claim 10, wherein the controller includes a boost circuit to store electrical energy to provide an electrical failsafe for the non-back drivable cam.

14. The system as claimed in claim 1, wherein the output member comprises an actuator pin or arm coupled to the control member.

15. The system as claimed in claim 1, wherein the contour surface is defined by a groove which receives and retains a free end portion of the output member therein.

16. The system as claimed in claim 15, wherein the groove has end portions and an intermediate portion between the end portions, the end portions providing an anti-backlash feature.

17. The system as claimed in claim 1, wherein the control member is a control or selector plate rotatable about the first axis.

18. The system as claimed in claim 17, wherein the control member has at least one opening which extends completely therethrough.

19. The system as claimed in claim 3, wherein the controller includes a boost circuit to enable the controller to provide electrical power to the actuator assembly above nominal input power normally available from a battery of the vehicle to boost output torque and speed of the actuator assembly.

20. The system as claimed in claim 19, wherein the cam is non-back drivable and wherein the boost circuit stores electrical energy to provide an electrical failsafe for the cam.

21. An overrunning coupling and electromechanical control assembly comprising:
a coupling subassembly including first and second coupling members having first and second coupling faces, respectively, in close-spaced opposition with one another, at least one of the members being mounted for rotation about a first axis;
a control member mounted for controlled rotation about the first axis between the coupling faces;
a bi-directional, electrically-powered actuator subassembly including an output member coupled to the control member for selective, small-displacement, control member angular rotation about the first axis between different angular positions which correspond to different operating modes of the coupling subassembly, the actuator subassembly including a rotary output shaft, a threaded screw shaft coupled to the output shaft to rotate about a second axis substantially perpendicular to the first axis and a cam having a contour surface, the cam being threaded onto the screw shaft to move linearly along the second axis upon rotary movement of the screw shaft, the output member riding on the contour surface of the cam so that the output member rotates with the control member about the first axis;
control logic operative to determine a desired operating mode of the coupling subassembly and to generate a corresponding position command signal; and
an actuator controller to controllably supply electrical power to the actuator subassembly to move the control member to a desired angular position based on the position command signal.

22. The assembly as claimed in claim 21, wherein the actuator controller receives the position command signal from a remote electronic control unit through a bus.

23. The assembly as claimed in claim 22, wherein the electronic control unit is a transmission electronic control unit of a vehicle and the bus is a vehicle-based bus.

24. The assembly as claimed in claim 21, wherein the actuator subassembly includes a DC motor having the output shaft for driving the control member.

25. The assembly as claimed in claim 24, wherein the actuator controller includes a current sensor to monitor motor current draw, the control logic controlling the DC motor based on the motor current draw.

26. The assembly as claimed in claim 24, wherein the actuator subassembly includes at least one non-contact position sensor to provide a position feedback signal as a function of the position of the cam along the second axis, the control logic controlling the DC motor based on the position feedback signal.

27. The assembly as claimed in claim 26, wherein each sensor includes at least one magnetic or ferromagnetic magnet mounted for movement with the cam and at least one magnetic field sensing element disposed adjacent and stationary with respect to the at least one magnet for sensing magnetic flux to produce the position feedback signal.

28. The assembly as claimed in claim 27, wherein each magnetic field sensing element is a Hall effect sensor.

29. The assembly as claimed in claim 21, wherein the cam is back-drivable on the screw shaft and wherein the assembly further comprises a return biasing member to exert a biasing force on the cam to return the cam to a position on the screw shaft which corresponds to a safe coupling mode when the actuator subassembly is de-energized.

30. The assembly as claimed in claim 21, wherein the cam is non-back drivable on the screw shaft.

31. The assembly as claimed in claim 30, wherein the controller includes a boost circuit to store electrical energy to provide an electrical failsafe for the non-back drivable cam.

32. The assembly as claimed in claim 29, further comprising a latching mechanism to prevent the cam from moving linearly on the screw shaft.

33. The assembly as claimed in claim 32, wherein the latching mechanism includes a latching solenoid.

34. The assembly as claimed in claim 21, wherein the output member comprises an actuator pin or arm coupled to the control member.

35. The assembly as claimed in claim 21, wherein the contour surface is defined by a groove which receives and retains a free end portion of the output member therein.

36. The assembly as claimed in claim 35, wherein the groove has end portions and an intermediate portion between the end portions, the end portions providing an anti-backlash feature.

37. The assembly as claimed in claim 21, wherein the control member is a control or selector plate rotatable about the first axis.

38. The assembly as claimed in claim 21, further comprising a locking member disposed between the coupling faces of the coupling members, the locking member being movable between first and second positions, the control member being operable to control position of the locking member.

39. The assembly as claimed in claim 38, wherein the locking member is a reverse strut.

40. The assembly as claimed in claim 37, wherein the control member has at least one opening which extends completely therethrough to allow the locking member to extend therethrough to the first position of the locking member in a control position of the control member.

41. The assembly as claimed in claim 23, wherein the controller includes a boost circuit to enable the controller to provide electrical power to the actuator subassembly above nominal input power normally available from a battery of the vehicle to boost output torque and speed of the actuator subassembly.

42. The assembly as claimed in claim 41, wherein the cam is non-back drivable and wherein the boost circuit stores electrical energy to provide an electrical failsafe for the cam.

43. The assembly as claimed in claim 21, wherein one of the coupling members includes a notch plate and the other of the coupling members includes a pocket plate.
